(19) United States
(12) Patent Application Publication
(10) Pub. No.: US 2013/0199923 A1
(43) Pub. Date: Aug. 8, 2013

(54) Method of Manufacturing Heterogeneous Catalyst Using Space Specificity

(71) Applicants: Jeung-Ku Kang, Daejeon (KR); Junghyo Park, Daejeon (KR); Kyung-Min Choi, Daejeon (KR); Jung-Hoon Choi, Daejeon (KR); Dong-Ki Lee, Daejeon (KR); Hyung-Joon Jeon, Daejeon (KR)

(72) Inventors: Jeung-Ku Kang, Daejeon (KR); Junghyo Park, Daejeon (KR); Kyung-Min Choi, Daejeon (KR); Jung-Hoon Choi, Daejeon (KR); Dong-Ki Lee, Daejeon (KR); Hyung-Joon Jeon, Daejeon (KR)

(73) Assignee: Korea Advanced Institute of Science and Technology, Daejeon (KR)

(21) Appl. No.: 13/538,003

(22) Filed: Jun. 29, 2012

(30) Foreign Application Priority Data
Feb. 7, 2012 (KR) 2012-0012376

(51) Int. Cl. B01J 37/16; B01J 23/745; B01J 23/42; B01J 23/75; B01J 23/44; B01J 21/06; B01J 37/34; B01J 21/08; B01J 31/06; C01B 3/04; B01J 35/02; B01J 23/46; B82Y 99/00; B82Y 40/00

(52) U.S. Cl. 204/157.52; 502/300; 502/338; 502/339; 502/325; 502/350; 502/5; 502/240; 502/158; 977/890; 977/773

(57) ABSTRACT

The present invention relates to a method of manufacturing a heterogeneous catalyst using space specificity, comprising: depositing a metal in a core of micelles provided on a substrate; depositing an oxide around a shell of the micelles after the deposition of the metal in the core of the micelle; and reducing the metal in the core of the micelles after the deposition of the oxide, then, removing the micelles, and a method for generation of hydrogen through decomposing water in the presence of the heterogeneous catalyst prepared according to the aforesaid method under a light source.

### CROSS-REFERENCE TO RELATED APPLICATIONS

This application claims priority from Korean Patent Application No. 10-2012-0012376, filed on Feb. 7, 2012 in the Korean Intellectual Property Office, the entire disclosure of which is incorporated herein by reference.

### FIELD OF THE INVENTION

The present invention relates to preparation of a heterogeneous catalyst using space specificity, and more particularly, to a method of manufacturing a heterogeneous catalyst using space specificity, which includes depositing metal in the center (‘core’) of micelles formed on a substrate, depositing an oxide around a peripheral part (‘shell’) of the micelles after metal deposition in the core of the micelles, and reducing the metal in the core of the micelles after oxide deposition and removing the micelles, a heterogeneous catalyst manufactured by the same, and a method for generation of hydrogen through decomposing water in the presence of the heterogeneous catalyst prepared according to the aforesaid method and under a light source.

Space specificity used in the present invention means that two different catalysts may be formed in a space for a heterogeneous catalyst wherein a metal catalyst may be formed in the core of the heterogeneous catalyst while an oxide catalyst may be formed around the shell of the heterogeneous catalyst except the core thereof.

### BACKGROUND OF THE INVENTION

A nano-sized catalyst exhibits electrical or optical properties that do not emerge in bulk state. In recent years, studies into synthesis of nano-sized catalyst particles are actively progressing, however, involving difficulties in synthesis thereof. Otherwise, even if nano-sized catalyst particles are successfully synthesized, it still remains a problem in synthesis of catalyst particles having uniform particle size. Furthermore, as the size of the catalyst is within the range of nano scales, aggregation of particles and difficulties in controlling the particles are tasks to be overcome.

Among catalyst particles, a homogeneous catalyst comprising a single material alone expresses deteriorated catalyst activity in a catalytic reaction. Therefore, several documents in related art have reported that, if a catalyst is prepared by blending two different materials together to form a mixture, the prepared catalyst exhibits noticeably increased activity because of synergistic effects based on two different catalyst components contained therein.

Existing method of preparing a heterogeneous catalyst may include; simply mixing two different materials after forming these materials into each solution, thus synthesizing the materials in a simple mixture state. However, such a heterogeneous catalyst may incur a problem such as restricted catalytic activity since one of the catalytic materials is completely isolated by the other one.

For a heterogeneous catalyst, if catalysts based on two different materials can be positioned on desired sites in single particles, these materials are not simply mixed but separated from each other, which in turn maximizes activity of the catalyst. However, such a technique as described above has never been disclosed while most catalyst particles are generally synthesized into a powder form. These catalyst particles cause aggregation of catalysts to hence deteriorate effects, as well as difficulties in recovering after catalytic reaction, thus entailing problems in industrial application thereof. Accordingly, there is still a strong requirement for improved technology of synthesizing a nano-scale catalyst wherein no aggregation between particles occurs during synthesis of a heterogeneous catalyst, individual materials may be placed in desired positions, respectively, and the constitutional compositions of particles can be easily adjusted.

Technologies for synthesis of high efficiency nano-catalyst have been broadly studied since long ago, however, a number of unsolved problems still exist. Specifically, as a catalyst is synthesized in nano scale, aggregation of catalyst particles may be incurred. In such the case, the surface area of a catalyst on which the catalytic reaction is occurring may be decreased due to catalyst aggregation, hence deteriorating the efficiency of catalyst. Moreover, it is significantly difficult to control positions of two different materials during synthesis of a heterogeneous catalyst. If two different materials can be placed on desired positions, respectively, by adjusting the positions of these two materials, a catalyst having excellent activity may be successfully obtained.

Therefore, the inventors of the present application have intended to prepare a heterogeneous catalyst in nano-scale in order to solve problems mentioned above. Also, there is provided a method of preparing such a heterogeneous catalyst as described above by utilizing space specificity, including: forming micelles, as a polymer material which is polar at the core while being non-polar around the shell thereof, on a substrate; depositing a catalyst in the core of the micelles formed on the substrate; and forming another catalyst around the shell of the micelles, other than the catalyst provided in the core thereof, to thereby prevent two different catalysts from being admixed.

Meanwhile, among prior arts in regard to the present invention, Korean Patent Laid-Open No. 2011-0045744 discloses a method of fabricating a hollow porous nickel-alumina composite catalyst wherein a cationic surfactant having a mean pore size of 2 to 10 nm and an active surface area of a nickel part ranging from 1 to 100 m²/g-Ni may be utilized as a structure inducer to concurrently execute hydration, condensation and heating a mixture composed of an aluminum precursor and a nickel precursor in an atomic ratio of nickel/aluminum ranging from 0.1 to 1.

However, unlike the foregoing prior art, the present invention may accomplish specified technical features distinguishable from the prior art, hence being demonstrated as a novel invention different from the foregoing prior art.

### SUMMARY OF THE INVENTION

Therefore, an object of the present invention is to provide a method of manufacturing a heterogeneous catalyst using space specificity.

Another object of the present invention is to provide a heterogeneous catalyst obtained by the method of manufacturing a heterogeneous catalyst using space specificity described above.

Yet another object of the present invention is to provide a method for production of hydrogen, including; decomposing water in the presence of the heterogeneous catalyst prepared by the method of manufacturing a heterogeneous catalyst using space specificity, as described above, and under a light source.

In order to accomplish the above objects, there is provided a method of manufacturing a heterogeneous catalyst using micelles, including: depositing a metal in the core of the micelles which is formed on a substrate; depositing an oxide around a shell of the micelles after metal deposition in the core thereof; and reducing the metal in the core after oxide deposition, then, removing the micelles.

The present invention may provide the heterogeneous catalyst prepared according to the aforesaid method.

The present invention may also provide a method for generation of hydrogen including decomposition of water (or ‘water decomposition’) in the presence of the heterogeneous catalyst prepared according to the aforesaid method and under a light source.

The heterogeneous catalyst prepared according to the present invention may be formed in a separate form, such that a core and a shell coexist in one nano-particle, hence expressing high catalytic features. Additionally, with regard to the synthesis of heterogeneous catalysts, since aggregation of particles does not occur and a process of altering constitutional composition of the heterogeneous catalyst is very simple, the foregoing technique may be suitably applied to manufacturing a catalyst used to synthesize methanol, hydrocarbons, etc., in addition to a photo-catalyst generating hydrogen through water decomposition.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating the synthesis of nano-sized heterogeneous catalyst using space specificity;

FIG. 2a illustrates SEM image of a Fe/SiO₂ heterogeneous catalyst, FIG. 2b illustrates an AFM phase mode image, FIG. 2c illustrates a TEM image, and FIG. 2d illustrates a TXRF image of the same;

FIG. 3a illustrates a schematic view, a SEM image (structure) and results of composition analysis through TXRF of a Fe/TiO₂ heterogeneous catalyst structure, FIG. 3b illustrates a schematic view, a SEM image (structure) and results of composition analysis through TXRF of a Pt/SiO₂ heterogeneous catalyst structure, and FIG. 3c illustrates a schematic view, a SEM image (structure) and results of composition analysis through TXRF of a Pt/TiO₂ heterogeneous catalyst structure; and

FIG. 4 illustrates an amount of hydrogen generated by water decomposition in the presence of the Pt/TiO₂ heterogeneous catalyst as well as platinum particles.

### DETAILED DESCRIPTION OF THE INVENTION

The present invention discloses a method of manufacturing a heterogeneous catalyst using space specificity.

The method of manufacturing a heterogeneous catalyst using space specificity disclosed by the present invention, includes depositing a metal in a core of micelles provided on a substrate; depositing an oxide around a shell of the micelles after the deposition of the metal in the core of the micelles; and reducing the metal in the core of the micelles after the deposition of the oxide, then, removing the micelles.

Herein, the deposition of the metal in the core of the micelles may be performed by depositing a metal in the core of the micelles by immersing the substrate provided with the micelles into a solution containing a metal precursor.

Herein, the metal may be deposited in the core of the micelles by immersing the substrate provided with the micelles into a solution containing a metal precursor of 0.1 to 0.5 M for 10 to 60 minutes.

The solution containing the metal precursor, as described above, may be a solution prepared by dissolving a metal precursor, i.e., an iron (Fe) precursor in methanol.

The Fe precursor may include, for example, at least one selected from iron (III) chloride (FeCl₃), iron (II) chloride (FeCl₂) and iron (II) chloride tetrahydrate (FeCl₂·4H₂O).

The solution containing the metal precursor may be a solution prepared by dissolving a metal precursor, i.e., a platinum (Pt) precursor in methanol.

The Pt precursor may include, for example, at least one selected from platinum (II) chloride (PtCl₂) and platinum (IV) chloride (PtCl₄).

The solution containing the metal precursor may be a solution prepared by dissolving a metal precursor, i.e., a cobalt (Co) precursor in methanol.

The Co precursor may include, for example, at least one selected from cobalt (II) chloride (CoCl₂) and cobalt (II) chloride hexahydrate (CoCl₂·6H₂O).

The solution containing the metal precursor may be a solution prepared by dissolving a metal precursor, i.e., a palladium (Pd) precursor in methanol.

The Pd precursor may include, for example, palladium (II) chloride (PdCl₂).

The solution containing the metal precursor may be a solution prepared by dissolving a metal precursor, i.e., a ruthenium (Ru) precursor in methanol.

The (Ru) precursor may include, for example, at least one selected from ruthenium (III) chloride (RuCl₃) and ruthenium (III) chloride hydrate (RuCl₅·xH₂O).

The solution containing the metal precursor may be a solution prepared by dissolving a metal precursor comprising a mixture of at least two selected from the Fe precursor, Pt precursor, Co precursor, Pd precursor and Ru precursor in methanol.

The solution containing the metal precursor may be a solution prepared by dissolving a metal precursor, which comprises a mixture of at least two selected from the Fe precursor, Pt precursor, Co precursor, Pd precursor and Ru precursor with equal ratios by weight, in methanol.

A substrate having micelles metal-deposited in the core thereof, an oxide precursor and water are placed in a sealed vessel, followed by heating the vessel at a temperature at which the oxide precursor and water are vaporized, thereby enabling the oxide to be deposited around the shell of the micelles.

In particular, after introducing a substrate having micelles metal-deposited in the core thereof, an oxide precursor and water into a sealed vessel, the oxide precursor and water are heated at 60 to 100° C. for 1 to 6 hours to thereby deposit the oxide around the shell of the micelles.

More specifically, after introducing a substrate having micelles metal-deposited in the core thereof, an oxide precursor and water into a sealed vessel, the oxide precursor and water are heated at 60° C. for 5 hours, thereby depositing the oxide around the shell of the micelles.

Contents of the oxide precursor and water in the sealed vessel, respectively, may range from 1 to 10 ml, preferably, 2 to 7 ml and, more preferably, 2 to 5 ml, in a vial glass.

The oxide precursor may be a silicon (Si) oxide precursor.

The Si precursor may include, for example, tetraethyl ortho-silicate.

The oxide precursor may be a titanium (Ti) precursor.

The Ti precursor may include, for example, titanium (IV) isopropoxide (Ti(OCH(CH₃)₂)₄).

The oxide precursor may be a mixture of the Si precursor and Ti precursor.

The oxide precursor may be a mixture of the Si precursor and Ti precursor in equal ratios by weight.

The sealed vessel may include any one capable of preventing vapor from discharging outside when the oxide precursor and water are vaporized. That is, since such a sealed vessel may be suitably chosen by persons having ordinary skill in the art to which the present invention pertains (hereinafter also refer to as “those skilled in the art”), a detailed description thereof will be omitted below.

The substrate including micelles provided thereon may be fabricated by: heating a solution containing a polymer dissolved therein, wherein the polymer is formed by block-copolymerization of a polar polymer and a non-polar polymer, to prepare the micelles; aligning the micelles on the substrate; and immersing the prepared substrate in a solvent.

Examples of the polymer formed by block-copolymerization of the polar polymer and the non-polar polymer may include; polystyrene-block-poly(4-vinyl-pyridine) (PSbPVP), polystyrene-poly(2-vinyl pyridine) (PS-P2VP) and asymmetric poly(styrene-block-ethylene oxide) (PS-b-PEO).

The solvent, in which the polymer comprising the polar polymer and non-polar polymer block-copolymerized with each other is dissolved, may be at least one selected from toluene and benzene.

The substrate provided with micelles may be fabricated by: heating a solution containing a polymer dissolved in toluene, wherein the polymer comprises polystyrene-block-poly(4-vinyl-pyridine) (PBPVP), to prepare the micelles; aligning the micelles on the substrate; and immersing the prepared substrate in a solvent.

Alternatively, the substrate provided with micelles may be fabricated by: heating a solution containing 0.1 to 1.0 wt. % polymer in toluene or benzene, wherein the polymer is selected from polystyrene-block-poly(4-vinyl pyridine), polystyrene-poly(2-vinyl pyridine) and poly(styrene-block-ethylene oxide), at 60 to 80° C. for 2 to 4 hours to prepare the micelles; aligning the micelles on the substrate; and immersing the prepared substrate in methanol for 5 to 12 hours.

Alternatively, the substrate provided with micelles may be fabricated by: heating a solution containing 0.5 wt. % polymer in toluene, wherein the polymer comprises polystyrene-block-poly(4-vinyl pyridine), at 60° C. for 3 hours to prepare the micelles; aligning the micelles on the substrate; and immersing the prepared substrate in methanol for 10 hours.

When aligning the micelles on the substrate, the micelles may be spin-coated before the aligning process.

Herein, the metal deposited in the core of the micelles may include, for example, any one selected from iron (Fe), platinum (Pt), cobalt (Co), palladium (Pd) and ruthenium (Ru), preferably, Fe and/or Pt.

Herein, the oxide deposited around the shell of the micelles may include, for example, any one selected from silicon dioxide (SiO₂) and titanium dioxide (TiO₂).

After reducing the metal in the core of the micelles, the micelles may be removed by UV treatment of the substrate wherein the core of the micelles are deposited with metal while the shell thereof is deposited with oxide.

In particular, after reducing the metal from the core of the micelles, the micelles may be removed by: placing the substrate in toluene, wherein the core of the micelles in the substrate are deposited with metal while the shell thereof is deposited with oxide; and conducting UV treatment by a light source using a xenon (Xe) lamp, with a light intensity of 700 to 900 W for 3 to 5 hours.

After reducing the metal from the core of the micelles, the micelles may be removed by: placing the substrate in toluene, wherein the core of the micelles in the substrate are deposited with metal while the shell thereof is deposited with oxide; and conducting UV treatment by a light source using a xenon (Xe) lamp, with a light intensity of 800 W for 4 hours.

After reducing the metal from the core of the micelles, the micelles may be removed by: placing the substrate in a chamber, wherein the core of the micelles in the substrate are deposited with metal while the shell thereof is deposited with oxide; feeding hydrogen with a pressure of 15 to 30 Torr into the chamber; and conducting plasma treatment with microwaves at 700 to 900 W and at 170 to 190° C. for 65 to 85 seconds.

After reducing the metal from the core of the micelles, the micelles may be removed by: placing the substrate in a chamber, wherein the core of the micelles in the substrate are deposited with metal while the shell thereof is deposited with oxide; feeding hydrogen with a pressure of 21 Torr into the chamber; and conducting plasma treatment with microwaves at 800 W and at 180° C. for 75 seconds.

The plasma treatment may comprise plasma enhanced chemical vapor deposition (PECVD).

The substrate provided with a micelle may be a Si substrate.

The substrate provided with a micelle may be a glass substrate.

The heterogeneous catalyst prepared by the aforesaid method may have a size ranging from several to several hundreds of nanometers (nm).

The heterogeneous catalyst prepared by the aforesaid method may have a size ranging from 5 to 500 nm.

The heterogeneous catalyst prepared by the aforesaid method may have a size ranging from 20 to 100 nm.

The heterogeneous catalyst prepared by the aforesaid method may have a size ranging from 25 to 50 nm.

The heterogeneous catalyst prepared by the aforesaid method, in which a metal catalyst is present in the core while an oxide catalyst is present around the shell except the core, may have a size of several to several hundreds of nm, preferably 5 to 500 nm, more preferably 20 to 100 nm, and most preferably 25 to 50 nm.

With regard to the method of manufacturing a heterogeneous catalyst using space specificity, the method was implemented under various conditions and, in order to accomplish the purposes of the present invention, it is preferable to provide the inventive method of manufacturing a heterogeneous catalyst using space specificity under the foregoing conditions.

The present invention may include a heterogeneous catalyst prepared according to the method described above.

The heterogeneous catalyst prepared according to the above method may have a size ranging from several to several hundreds of nm, preferably 5 to 500 nm, more preferably 20 to 100 nm, and most preferably 25 to 50 nm.

The present invention may further include a method for generation of hydrogen (H₂) by water (H₂O) decomposition in the presence of the heterogeneous catalyst prepared according to the foregoing method under a light source.

The light source may be sunlight.

The light source may be a xenon lamp (Xe lamp) with 100 to 500 W.

The light source may be a Xe lamp with 300 W.

Preferred embodiments will be described to allow a more concrete understanding of the present invention with reference to examples and comparative examples. However, it will be apparent to those skilled in the art that such embodiments are provided for illustrative purposes and do not limit subject matters to be protected as defined by the appended claims.

### EXAMPLE 1

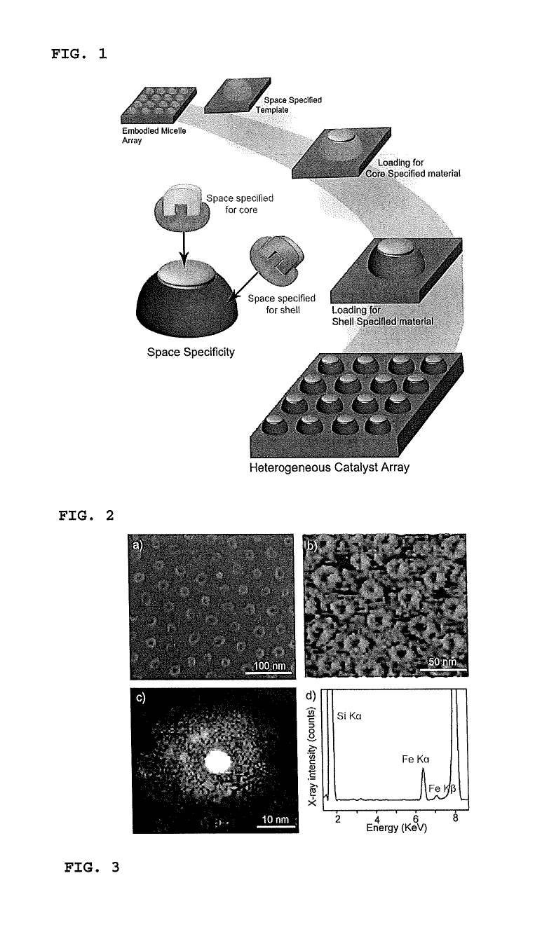

According to the process illustrated in FIG. 1, a heterogeneous catalyst comprising a metal catalyst provided in the core while an oxide catalyst was provided around the shell thereof except the core was prepared and an example of the preparation process of the heterogeneous catalyst will be described in detail by the following operations.

(1) A polymer, i.e., polystyrene-block-poly(4-vinyl pyridine)[a weight mean molecular weight of polystyrene: 47600, a weight mean molecular weight of poly(4-vinyl pyridine): 20600] was added to a toluene solvent to reach a concentration of 0.5 wt. %, the mixture was agitated at 300 rpm for 24 hours to allow the polymer to be completely dissolved in toluene, followed by annealing at 60° C. for 3 hours, to thereby prepare micelles.

The micelles were spin-coated on a Si substrate and immersed in methanol for 10 hours.

(2) The micelles formed on the Si substrate obtained in the above operation (1) were immersed in a 0.1 M methanol solution containing iron (III) chloride (FeCl₃) as a Fe precursor for 10 minutes, hence rendering metal (Fe) ions to be deposited in the core of the micelles formed on the substrate.

(3) After completing the deposition of metal (Fe) ions in the core of the micelles formed on the silicone substrate in the above operation (2), an oxide was deposited around the shell of the micelles formed on the substrate through vapor deposition. For this purpose, a vial glass containing 5 ml of tetraethyl ortho-silicate, as a silicon (Si) oxide precursor, another vial glass containing 5 ml of water, and the Si substrate containing micelles metal (Fe) ion-deposited in the core thereof, were introduced into a sealed vessel. The sealed vessel was placed in an oven and a temperature was raised to 60° C., followed by conducting deposition for 5 hours. A gas generated from the silicon (Si) oxide precursor and a vapor generated from water may react with each other to produce a silica oxide (SiO₂) around the shell of the micelles except the core of the micelles deposited with the metal (Fe) ions.

(4) After completing the deposition of the metal ions in the core and the oxide around the shell of the micelles in the above operation (3), plasma treatment using hydrogen was conducted to reduce the metal ions present in the core of the micelles, and the micelles were removed to produce a Fe/SiO₂ heterogeneous catalyst which includes a metal (Fe) catalyst formed in the core and a silicon dioxide (SiO₂) catalyst formed around the shell of the micelles. Here, the plasma treatment using hydrogen may be performed through plasma enhanced chemical vapor deposition (PECVD), wherein the substrate resulting after the deposition of the metal ions in the core and the oxide around the shell of the micelles was placed in a chamber, hydrogen was blown into the chamber at 21 Torr, and plasma treatment was executed with microwaves at 800W and at 180° C. for 75 seconds.

The resultant heterogeneous catalyst according to the operations (1) to (4) was illustrated in FIG. 2.

Specifically, FIG. 2a illustrates a scanning electron microscopic (SEM) image of the heterogeneous catalyst having Fe/SiO₂ composition. As shown in the SEM image, due to a difference in contrast between the core and the shell, it was confirmed that two different materials are present in the core and the shell, respectively. It can also be seen that the catalyst has a uniform size of 25 nm. FIG. 2b illustrates an image measured by phase mode using atomic force microscopy (AFM) of the heterogeneous catalyst having Fe/SiO₂ composition, and a remarkable difference in contrast can be confirmed since the materials in the core and the shell are substantially different from each other. In addition, FIG. 2c illustrates a transmission electron microscopic (TEM) image of the heterogeneous catalyst having Fe/SiO₂ composition, wherein a bright area in the core is a metal portion while a dark area around the shell is an oxide portion, hence being obviously distinguished from each other. Finally, FIG. 2d illustrates measured results of total X-ray fluorescence (TXRF) in order to analyze components of the heterogeneous catalyst having Fe/SiO₂ composition, and it can be confirmed that iron (Fe) as a metal catalyst and silica (Si) component as a main ingredient of an oxide catalyst are present in the heterogeneous catalyst.

### EXAMPLE 2

Except that a titanium dioxide (TiO₂) precursor, i.e., titanium (IV) isopropoxide (Ti(OCH(CH₃)₂)₄) was used in place of a silicon (Si) oxide precursor such as tetraethyl ortho-silicate, the same procedure as described in Example 1 was applied to produce a Fe/TiO₂ heterogeneous catalyst wherein a metal (Fe) catalyst is formed in the core while a titanium dioxide (TiO₂) catalyst is present around the shell of a heterogeneous catalyst other than the core part.

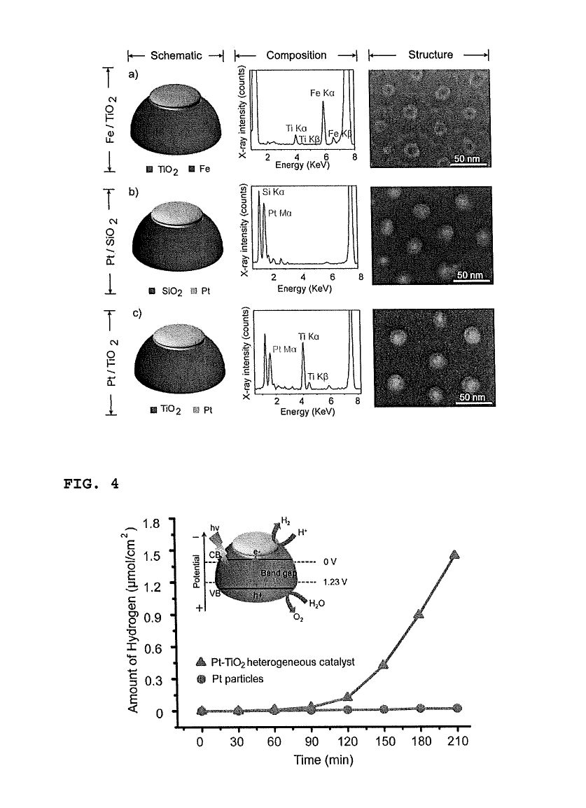

FIG. 3a illustrates a structural schematic view, SEM image (structure) and results of composition analysis through TXRF of the Fe/TiO₂ heterogeneous catalyst, as prepared above.

### EXAMPLE 3

Except that a platinum (Pt) precursor, i.e., platinum (II) chloride (PtCl₂) was used in place of an iron (Fe) precursor such as iron (III) chloride (FeCl₃), the same procedure as described in Example 1 was applied to produce a Pt/SiO₂ heterogeneous catalyst wherein a metal (Pt) catalyst is formed in the core while a silicon dioxide (SiO₂) catalyst is present around the shell of a heterogeneous catalyst other than the core part.

FIG. 3b illustrates a structural schematic view, a SEM image (structure) and results of composition analysis through TXRF of the Pt/SiO₂ heterogeneous catalyst, as prepared above.

### EXAMPLE 4

Except that a platinum (Pt) precursor, i.e., platinum (II) chloride (PtCl₂) was used in place of an iron (Fe) precursor such as iron (III) chloride (FeCl₃) and, in addition, a titanium dioxide (TiO₂) precursor, i.e., titanium (IV) isopropoxide (Ti(OCH(CH₃)₂)₄) was used in place of a silicon (Si) oxide precursor such as teteraethyl ortho-silicate, the same procedure as described in Example 1 was applied to produce a Pt/TiO₂ heterogeneous catalyst wherein a metal (Pt) catalyst is formed in the core while a titanium dioxide (TiO₂) catalyst is present around the shell of a heterogeneous catalyst other than the core part.

FIG. 3c illustrates a structural schematic view, a SEM image (structure) and results of composition analysis through TXRF of the Pt/TiO₂ heterogeneous catalyst, as prepared above.

### EXPERIMENTAL EXAMPLE

Among the heterogeneous catalysts prepared in Examples 1 to 4, the Pt/TiO heterogeneous catalyst prepared in Example 4 was expected to have the highest activity and hence used. More particularly, water decomposition was performed in the presence of the Pt/TiO₂ heterogeneous catalyst and under a light source to generate hydrogen. This is defined as an experimental group.

Meanwhile, hydrogen was generated through water decomposition using Pt particles under a light source and used as a control group.

Measurement of hydrogen generation was executed by pouring 75 ml of purified water into a 90 ml cylindrical quartz tube, purging with argon gas (Ar) for 30 minutes, and measuring an amount of hydrogen generated while emitting light by means of a Xe lamp at 300 W for 3 hours. Then, the generated hydrogen was subjected to sampling using a 200 μl syringe and measurement of the amount of the generated hydrogen through gas chromatography. The measured results are shown in FIG. 4.

It was confirmed that a total amount of hydrogen generated over 210 minutes (3 hours and 30 minutes) in the experimental group was about 1.5 μmol/cm², whilst the control group almost did not generate hydrogen, as shown in FIG. 4. From the above results, it can be seen that, when hydrogen is generated by water decomposition using the heterogeneous catalyst prepared in the present invention, a considerably larger amount of hydrogen may be obtained, compared to hydrogen generation by water decomposition using platinum particles as a catalyst.

The results shown in FIG. 4 substantially demonstrate that the heterogeneous catalyst comprising a metal catalyst formed in the core and an oxide catalyst formed in the shell except the core part of the heterogeneous catalyst exhibits high activity owing to synergetic effects of the above two different catalysts, thereby expressing superior catalytic effects over a single catalyst.

Meanwhile, CB in FIG. 4 means a conduction band while VB refers to a valence band.

### EXAMPLE 5-1

(1) A polymer, i.e., polystyrene-block-poly(4-vinyl pyridine)[a weight mean molecular weight of polystyrene: 47600, a weight mean molecular weight of poly(4-vinyl pyridine): 20600] was added to a toluene solvent to reach a concentration of 0.5 wt. %, the mixture was agitated at 300 rpm for 24 hours to allow the polymer to be completely dissolved in toluene, followed by annealing at 60° C. for 3 hours, to thereby prepare micelles.

The micelles were spin-coated on a Si substrate and immersed in methanol for 10 hours.

(2) The micelles formed on the Si substrate obtained in the above operation (1) were immersed in a 0.1 M methanol solution containing cobalt (II) chloride (CoCl₂) as a Co precursor for 10 minutes, hence rendering metal (Co) ions to be deposited in the core of the micelles formed on the substrate.

(3) After completing the deposition of metal (Co) ions in the core of the micelles formed on the silicone substrate in the above operation (2), an oxide was deposited around the shell of the micelles formed on the substrate through vapor deposition. For this purpose, a vial glass containing 5 ml of tetraethyl ortho-silicate, as a silicon (Si) oxide precursor, another vial glass containing 5 ml of water, and the Si substrate containing micelles metal (Co) ion-deposited in the core thereof, were introduced into a sealed vessel. The sealed vessel was placed in an oven and a temperature was raised to 60° C., followed by conducting deposition for 5 hours. A gas generated from the silicon (Si) oxide precursor and a vapor generated from water may react with each other to produce a silica oxide (SiO₂) around the shell of the micelles except the core of the micelles deposited with the metal (Co) ions.

(4) After completing the deposition of the metal ions in the core and the oxide around the shell of the micelles in the above operation (3), plasma treatment using hydrogen was conducted to reduce the metal ions present in the core of the micelles, and the micelles were removed to produce a Co/SiO₂ heterogeneous catalyst which includes a metal (Co) catalyst formed in the core and a silicon dioxide (SiO₂) catalyst formed around the shell of the micelles. Here, the plasma treatment using hydrogen may be performed through plasma enhanced chemical vapor deposition (PECVD), wherein the substrate resulting after the deposition of the metal ions in the core and the oxide around the shell of the micelles was placed in a chamber, hydrogen was blown into the chamber at 21 Torr, and the plasma treatment was executed with microwaves at 800 W and at 180° C. for 75 seconds.

### EXAMPLE 5-2

Except that a palladium (Pd) precursor such as palladium (II) chloride (PdCl₂) was used in place of cobalt (II) Chloride (CoCl₂) as a Co precursor, the same procedure as described in Example 5-1 was applied to produce a Pd/SiO₂ heterogeneous catalyst wherein a metal (Pd) catalyst is formed in the core while a silicon dioxide (SiO₂) catalyst is present around the shell of heterogeneous catalyst other than the core part.

### EXAMPLE 5-3

Except that a ruthenium (Ru) precursor such as ruthenium (III) chloride (RuCl₃) was used in place of cobalt (II) Chloride (CoCl₂) as a Co precursor, the same procedure as described in Example 5-1 was applied to produce a Ru/SiO₂ heterogeneous catalyst wherein a metal (Ru) catalyst is formed in the core while a silicon dioxide (SiO₂) catalyst is present around the shell of heterogeneous catalyst other than the core part.

### EXAMPLE 6-1

Except that a titanium (Ti) dioxide precursor such as titanium (IV) isopropoxide (Ti(OCH(CH₃)₂)₄) was used in place of tetraethyl ortho-silicate as a silicon (Si) oxide precursor, the same procedure as described in Example 5-1 was applied to produce a Co/TiO₂ heterogeneous catalyst wherein a metal (Co) catalyst is formed in the core while a titanium dioxide (TiO₂) catalyst is present around the shell of heterogeneous catalyst other than the core part.

### EXAMPLE 6-2

Except that a palladium (Pd) precursor such as palladium (II) chloride (PdCl₂) was used in place of cobalt (II) Chloride (CoCl₂) as a Co precursor and, in addition, a titanium (Ti) dioxide precursor such as titanium (IV) isopropoxide (Ti(OCH(CH₃)₂)₄) was used in place of tetraethyl ortho-silicate as a silicon (Si) oxide precursor, the same procedure as described in Example 5-1 was applied to produce a Pd/TiO₂ heterogeneous catalyst wherein a metal (Pd) catalyst is formed in the core while a titanium dioxide (TiO₂) catalyst is present around the shell of heterogeneous catalyst other than the core part.

### EXAMPLE 6-3

Except that a ruthenium (Ru) precursor such as ruthenium (III) chloride (RuCl₃) was used in place of cobalt (II) Chloride (CoCl₂) as a Co precursor and, in addition, a titanium (Ti) dioxide precursor such as titanium (IV) isopropoxide (Ti(OCH(CH₃)₂)₄) was used in place of tetraethyl ortho-silicate as a silicon (Si) oxide precursor, the same procedure as described in Example 5-1 was applied to produce a Pd/SiO₂ heterogeneous catalyst wherein a metal (Ru) catalyst is formed in the core while a titanium dioxide (TiO₂) catalyst is present around the shell of heterogeneous catalyst other than the core part.

The nano-sized heterogeneous catalyst produced according to the present invention may have advantages of simple manufacturing process and possibility of mass production. In addition, other preferable characteristics, i.e., a large specific surface area, excellent chemical and thermal properties, stable recycling features, and the like, may be successfully attained.

Moreover, the heterogeneous catalyst produced according to the present invention is used as a catalyst to generate hydrogen through water decomposition and hence enables hydrogen to be generated in large quantities, thereby realizing industrial availability.

Although preferred embodiments of the present invention have been described above in conjunction with the accompanying examples and experimental examples, those skilled in the art will appreciate that various modifications and alterations are possible without departing from the scope and spirit of the invention, based on the foregoing description and the appended claims.

What is claimed is:

1. A method of manufacturing a heterogeneous catalyst using space specificity, comprising:
depositing a metal in a core of micelles provided on a substrate;
depositing an oxide around a shell of the micelles after the deposition of the metal in the core of the micelle; and
reducing the metal in the core of the micelles after the deposition of the oxide, then, removing the micelles.

2. The method according to claim 1, wherein the deposition of the metal in the core of the micelles is performed by depositing a metal in the core of the micelles by immersing the substrate provided with the micelles into a solution containing a metal precursor.

3. The method according to claim 1, wherein the metal is deposited in the core of the micelles by immersing the substrate provided with the micelles into a solution containing a metal precursor of 0.1 to 0.5 M for 10 to 60 minutes, wherein the solution containing the metal precursor comprises a solution prepared by dissolving any one metal precursor selected from a Fe precursor, a Pt precursor, a Co precursor, a Pd precursor and a Ru precursor in methanol.

4. The method according to claim 1, wherein the deposition of the oxide around the shell of the micelles is performed by placing the substrate provided with the micelles metal-deposited in the core of the micelles, the oxide precursor and water in a sealed vessel, and heating the same at a temperature at which the oxide precursor and water are vaporized.

5. The method according to claim 1, wherein the deposition of the oxide around the shell of the micelles is performed by placing the substrate provided with the micelles metal-deposited in the core of the micelles, the oxide precursor and water in a sealed vessel, and heating the same at 60 to 100° C. for 1 to 6 hours, and wherein the oxide precursor comprises an oxide precursor of any one selected from a silicon (Si) precursor and a titanium (Ti) precursor.

6. The method according to claim 1, wherein the micelles are obtained by heating a solution containing any one polymer selected from polystyrene-block-poly(4-vinyl pyridine), polystyrene-block-poly(2-vinyl pyridine) and poly(styrene-block-ethylene oxide) dissolved in any one solvent selected from toluene and benzene, and then, aligned on the substrate, followed by immersing the micelles in a solvent to produce the substrate provided with the micelles.

7. The method according to claim 1, wherein the micelles are obtained by heating a solution containing 0.1 to 1.0 wt. % of any one polymer selected from polystyrene-block-poly(4-vinyl pyridine), polystyrene-block-poly(2-vinyl pyridine) and poly(styrene-block-ethylene oxide) dissolved in any one solvent selected from toluene and benzene at 60 to 80° C. for 2 to 4 hours, and then, aligned on the substrate, followed by immersing the micelles in methanol for 5 to 12 hours to produce the substrate provided with the micelles.

8. The method according to claim 1, wherein the metal deposited in the core of the micelles comprises any one selected from iron (Fe), platinum (Pt), cobalt (Co), palladium (Pd) and ruthenium (Ru).

9. The method according to claim 1, wherein the oxide deposited around the shell of the micelles comprises any one selected from silicon dioxide (SiO₂) and titanium dioxide (TiO₂).

10. The method according to claim 1, wherein the metal in the core of the micelles is reduced and then the micelles are removed by UV treatment of the substrate including the micelles wherein a metal is deposited in a core of the micelles while an oxide is deposited around a shell of the micelles or, otherwise, by placing the substrate including the micelles wherein a metal is deposited in a core of the micelles while an oxide is deposited around a shell of the micelles in a chamber, introducing hydrogen with 15 to 30 Torr into the chamber, and conducting plasma treatment with microwaves at 700 to 900 W and at 170 to 190° C. for 65 to 85 seconds.

11. The method according to claim 1, wherein the substrate comprises a silicone substrate or glass substrate.

12. A heterogeneous catalyst manufactured according to claim 1.

13. A method for generation of hydrogen (H₂) through water (H₂O) decomposition, comprising:
decomposing water in the presence of the heterogeneous catalyst manufactured by the method according to claim 1 under a light source.
